(19) United States
(12) Patent Application Publication
(10) Pub. No.: US 2009/0294437 A1
(43) Pub. Date: Dec. 3, 2009

(54) Device for heating up a heating element

(75) Inventors: José Miguel Burdio Pinilla, Zaragoza (ES); Jochen Bühner, Königsbach (DE); Jose Ramon Garcia Jiménez, Zaragoza (ES); Pablo Jesus Hernandez Blasco, Zaragoza (ES); Dirk Hoffmann, Traunstein (DE); Sergio Llorente Gil, Zaragoza (ES); Alfonso Lorente Perez, Zaragoza (ES); Fernando Monterde Aznar, Zaragoza (ES)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 11/921,814

(22) PCT Filed: Apr. 24, 2006
(86) PCT No.: PCT/EP2006/061778

§ 371 Date: May 15, 2009

(30) Foreign Application Priority Data
Jun. 8, 2005 (ES) P200501471

(51) Int. Cl. H05B 6/12; H05B 6/02

(52) U.S. Cl. 219/627; 219/600

(57) ABSTRACT

A device, in particular, for inductively heating up a heating element by means of an inductor and an element for recording a reference quantity which is dependent on the temperature of the heating element and derived from the electric quantity of the inductor in such a way that it makes it possible to form the reference value from the reference quantity and to adjust the temperature according to the reference quantity adjustment by means of the reference value. The aim of said invention is to carry out a reliable adjustment of a water temperature or of a cooked product even at extreme conditions or when the reference value is incorrect. For this purpose, the device comprises a correction means for correcting the reference value.

The invention relates to a device, in particular for inductively heating up a heating element according to the preamble of claim 1.

WO 2004/103028 A1 discloses a temperature controller for an induction furnace, in which an operator can start the control operation at a desired point in time by input of a corresponding command. A control unit records a value of a controlled variable associated with the temperature of a cooking vessel at this start time and controls the output of the inductor in such a way that the controlled variable remains as close as possible to this reference value. The controlled value of the temperature controller is derived from an electrical variable of the inductor of the induction furnace. For example, if water in the cooking vessel readily begins to boil following heating up of the cooking vessel, the operator can allow the water to continue to simmer as desired by initiating the control process.

The object of the present invention is to provide a device of the type in question with which the temperature of a heating element, or the temperature of a cooked product at the heating element, may be controlled more reliably. This object is achieved according to the invention by the features of claim 1. Advantageous embodiments and developments of the invention may be found in the subclaims.

The invention is based on a device for heating up a heating element in particular with an inductor, a radiant element or a gas burner, and on a means for recording a reference variable dependent upon a temperature of the heating element and derived from an electrical variable of the inductor for the purpose of forming a reference value from the reference variable and controlling the temperature on the basis of control of the reference variable with the aid of the reference value. It is proposed that the device comprises a correcting means for correcting the reference value. The reference value may be corrected manually by an operator or automatically, or adjusted to new requirements in such a way that uniform retention of a desired temperature may be achieved by simple means. A reference variable dependent upon the temperature of the heating element, which variable is derived from an electrical variable of the inductor, conventionally correlates with the temperature of a merely very thin layer of the heating element, for example of a pan base, which layer faces towards the inductor. The temperature of this very thin layer does not necessarily correspond to the temperature of, for example, cooked product or water in the pan. In the case where the pan is rapidly heated up by a supplied large heat output, the pan base for example, in particular the lowermost layer of the pan base, is already substantially hotter than the boiling point of water when the water first begins to boil. If the automatic temperature control is initiated by an operator at this time, and if the reference value is formed from the reference variable and the reference variable is kept as close as possible to the reference value, it may be that the pan base remains held at a very hot temperature, the initially simmering water begins to boil briskly, and an operator would like to reduce the supplied heat output. With the use of the correcting means, the reference value may be corrected and the reference variable adjusted with the aid of the new reference value, in particular to match the new reference value. This applies correspondingly to devices in which the temperature of a wall of the heating element is cooled with an infrared sensor in a known way, or in which a temperature sensor is arranged beneath a plate for deposition of the heating element. In this arrangement the device has e.g. a radiant element or a gas burner.

Depending on the selection of electrical variable or electrical variables of the inductor, from which variable or variables the reference variable is derived, the reference variable may also depend upon the output of the inductor. If the output is changed suddenly, for example by initiation of the temperature control by an operator, the reference variable may fluctuate greatly and the temperature control may take place in an unreliable and undesirable manner. In this case also, reliable temperature control may be simply achieved by correcting the reference value, for example after the heating system has settled into its steady state. A corresponding situation applies in the case of devices with radiant elements or gas burners.

Recording of the reference variable may take place by measuring and/or calculating. The reference value used may be the value of the reference variable at a specific point in time, for example the starting time. The means for recording the reference variable may comprise the correcting means. It is also possible for a control unit, for example a microcontroller, to contain both the means for recording the reference variable and the correcting means. The correcting means may be a matching means for matching the reference value to a new state or a new condition. The reference variable may be used as a controlled variable. It is purposefully adjusted to the reference value. The reference value may be constant over time or be a function of time.

In an advantageous embodiment of the invention, the correcting means has an inputting means for input of a correction command by an operator for the purpose of correcting the reference value. The reference value and therewith the temperature control may be adjusted by simple means manually and reliably to the requirements of the operator.

The correcting means is purposefully prepared for the purpose of altering the reference value by a correcting value in response to a correction command. The reference value is hereby corrected in discrete steps, as a result of which the correction per se, retracing of the correction and handling by an operator are kept simple.

In a further embodiment of the invention, the correcting means is prepared for the purpose of automatically correcting the reference value at the start of the temperature control, in particular for altering it by a correction value. This correction is especially advantageous in the case of systematic errors induced for example by a dependence of the reference variable on the output of the inductor. The reference value may be calculated at the start of the temperature control and subsequently corrected. It is also possible for the reference value to be determined at the start of the temperature control on the basis of an already corrected calculation or from the corrected reference variable, without said reference value being previously determined uncorrected. The start of the temperature control may occur automatically or in response to an operator command.

An especially simple correction occurs when the correction value is a preset value. The correction value may be an absolute value or a relative value which depends, for example, on the magnitude of the reference variable. In the case of dependence of the correction value on the reference variable—as a preset or non-preset value—an especially operator-friendly correction can be achieved, since multiple corrections can be avoided. In the case of a high temperature of the heating element, the correction value may, for example, be greater than in the case of a low temperature. Moreover, in the case of a high output of the inductor at the start of the temperature control, a higher correction value may be selected than if the output were lower.

The correction value is advantageously dependent upon a heating parameter determined prior to the control, for example the heat output, the temperature of the heating element, or for example a temperature gradient of the heating element. By this means corrections may be made very rapidly and multiple corrections may be avoided. Rapid and effective correction may similarly be achieved by the correction value being dependent upon a determined characteristic of a cooked product to be heated up. For example, if there is a lot of water—in what follows also considered to be a cooked product—in the pan to be heated up, a large correction value may be selected, and if there is little water a small one may be selected.

It is also proposed that the correction means is prepared for the purpose of correcting the reference variable following a signal start at the beginning of the temperature control and of forming the reference value from the corrected reference variable. By this means, the device may be brought from an extreme situation, for example the use of a maximal output, prior to a determination of the reference value, and brought into the state which it has during the temperature control. The reference value may be formed from a reference variable which is determined in a state that is at least similar to the state during the temperature control, and a systematic error in the determination of the reference value can be corrected and a reliable temperature control achieved.

The state of the device may be brought from an extreme state especially simply, if the correction comprises e.g. a reduction in the output of the inductor to an intermediate value. Intermediate value is to be understood as an output value which, from a chronological point of view, is positioned downstream of the start signal and upstream of the control phase.

The intermediate value is advantageously a value already established prior to the start signal, by means of which a very simple correction is achieved. An especially effective correction may be achieved when the intermediate value substantially corresponds to the output required to maintain a desired temperature of the heating element, in particular the temperature exhibited by the heating element at the time of the start signal. As a result of this, the state of the device at the time of determination of the reference value is similar to the state assumed by said device during the control operation, with the result that a dependence of the reference variable on, for example, the output of the inductor can be substantially abolished as a trigger of a systematic error.

Further advantages will emerge from the following description of the drawings. The drawings represent exemplary embodiments of the invention. The drawings, the description and claims contain numerous features in combination. The person skilled in the art will expediently also consider the features individually, and combine them into advantageous further combinations.

The drawings are as follows:

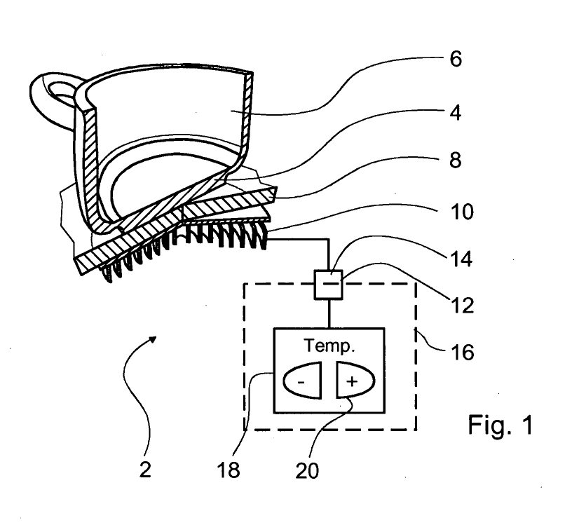

FIG. 1: A device for inductively heating up a heating element in a schematic view;

FIG. 2: A diagram on which a reference variable for a temperature controller, the output of the inductor, and the water and pan temperature are plotted against time;

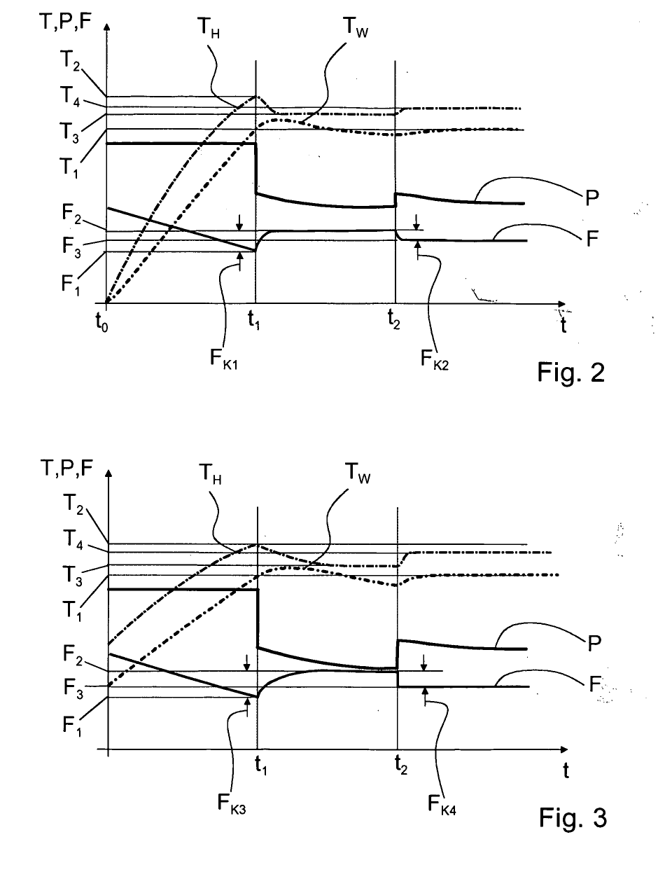

FIG. 3: The diagram as in FIG. 2 with a larger quantity of water in the pan;

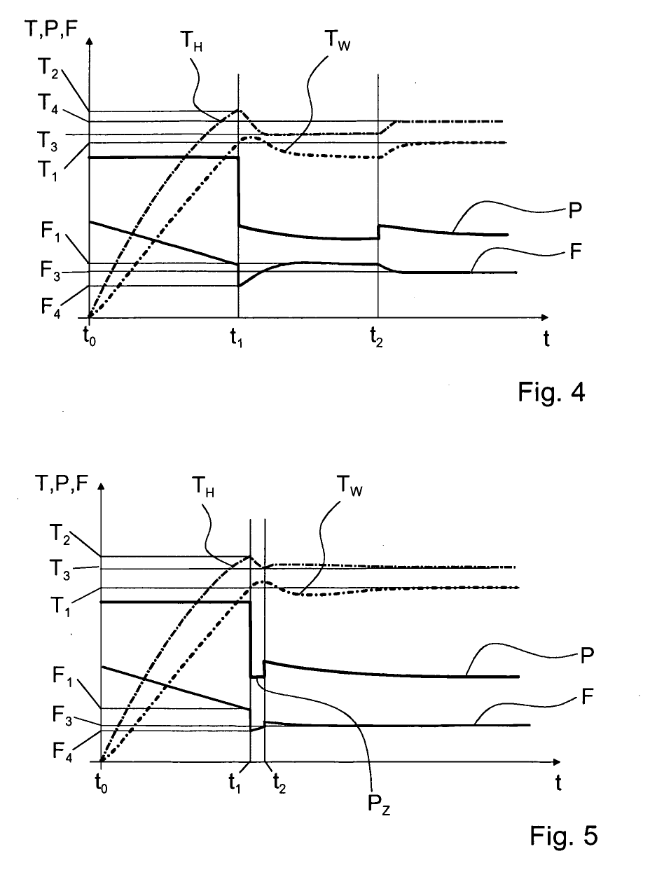

FIG. 4: The diagram from FIG. 2 with a systematic error in the reference variable, and

FIG. 5: The diagram from FIG. 4, in which the systematic error has been eliminated.

FIG. 1 shows a device 2 for inductively heating up a heating element 4 in the form of a pan base of a pan 6. For the purpose of heating, the pan 6 stands on a base plate 8 under which an inductor 10 is arranged. Connected to the inductor 10, there is a control unit 12 comprising a means 14 for recording a reference variable dependent upon the temperature of the heating element 4 and derived from an electrical variable of the inductor 10. The device 2 also has a correcting means 16, comprising parts of the control unit 12 and an inputting means 18 for input of the correction command by an operator. The inputting means 18 has two keys 20 with which a reference value formed by the control unit 12—and therewith a target temperature of the heating element 4—may be corrected in an upward or downward direction. Alternatively, a radiant-heat carrier or a gas burner may also be provided as the heat source. The means 14 may be formed on a temperature sensor arranged above or below the base plate 8. The measured temperature forms the reference variable F; it may deviate more or less markedly from the actual temperature T of the pan 6.

FIG. 2 shows a diagram in which the temperature T_{H} of the heating element 4 during inductive eating is plotted against time t. The temperature T_{W} of water simultaneously heated in the pan 6 by heating up of the heating element 4 is also plotted against time t. The temperature T_{W} here gives the temperature T_{W} of the lowermost layer of water in the pan 6, which layer is adjacent to the heating element 4. Water layers lying thereabove are somewhat colder whilst the water is being heated up. In FIG. 2, the heat output P of the inductor 10 is plotted against time t using a thick continuous line. A reference variable F is additionally plotted against time t, said variable F being determined by the means 14 from the inductivity of the system with the inductor 10 and the heating element 4, and in particular from the current flow through the inductor 10.

At the start of a heating-up process at time t₀, both the heating element 4 and the water lying thereabove are at, for example, room temperature. For heating up of the heating element 4 and of the water, the heat output P is switched to a relatively high level, the heating element 4 is heated up and therewith—somewhat delayed in time—the water above the heating element 4. With the increase in temperature T_{H}, the inductivity of the system comprising the heating element 4 decreases and therewith also the reference variable F.

At time t₁ the water has reached the temperature T₁, which an operator would like to maintain. For example, the water has begun to boil gently. By simultaneously pressing the two keys 20, the operator generates a start signal for initiating a temperature control. During this temperature control, the reference variable F, and therewith the temperature T_{H} of the heating element 4, are maintained at a constant level in order also to maintain the water thereabove at a constant temperature level. At time t₁, the heating element 4 has, in its lowermost layer which is most relevant for recording of the reference variable, the temperature T₂, which may be, for example, 115° C. and therefore not inconsiderably above the temperature T₁ of the water, 100° C. If the heating element 4 were now to remain constantly at the temperature T₂ of 115° C., the heating element 4 would, as during the heating up process, continue to give off heat to the water, and the water would be heated more strongly and ultimately boil briskly.

In order to prevent this, the control process is initiated as follows: the reference variable F has, at time t₁, decreased by a very large amount and has reached a reference value F₁, which may be recorded by the means 14 or derived from the reference variable F. In response to the start signal, the reference value F₁ is raised by the correcting means 16 by a preset correction value F_{K1}, to a new reference value F₂. The reference variable F is now adjusted to the new reference value F₂, by markedly reducing the heat output P of the inductor 10. As a result of this, the heating element 4 cools from the temperature T₂ of 115° C. to temperature T₃, for example, 107° C. The water temperature T_{W} still fluctuates somewhat above the temperature T₁, since a certain quantity of heat of high temperature T_{H} is still stored in the heating element 4 and given off to the water. However, by mixing of the water layers in the pan 6, the lower layer of the water now cools slowly and falls for example below the temperature T₁, which the operator had specified as a desired temperature, the water stops boiling and is perceived as being too cold by the operator. By operating the key 20 with the “+”, the latter triggers a correction of the reference value F₂ by a new, preset correction value F_{K2}, to a new reference value F₃. By this means the temperature T_{H} of the heating element 4 is set to a somewhat higher temperature T₄, by which the water is heated up somewhat, reaches the desired temperature T₁ and for example again simmers lightly.

FIG. 3 shows the control process as represented in FIG. 2, the pan 6 containing, however—as distinct from FIG. 2—a considerably greater quantity of water. With equal heat output P of the inductor 10 following an initiation of heating, not shown in FIG. 3, the temperature T_{H} of the heating element 4, and therewith the temperature T_{W} of the water, rises substantially more slowly than in FIG. 2. This lesser temperature gradient of the heating element 4 is recorded by the control unit 12. At the start signal at time t₁, the reference value F₁ is corrected by a correction value F_{K3} to the new reference value F₂, which is selected to be greater than the correction value F_{K1} from FIG. 2 since, from the heat output P in association with the small temperature gradient of the heating element 4, a large water volume has been concluded and the correction value F_{K3} has been set in dependence on the volume of water. In FIG. 3, as in FIG. 2, the temperature T_{W} of the water falls below the desired temperature T₁ due to mixing of the water, and the operator corrects the temperature T_{H} accordingly at time t₂ by operating the key 20 with the “+”. By this correction, the reference value F₂ is corrected via a correction value F_{K4} to a new reference value F₃, the correction value F_{K4} being greater than the correction value F_{K2} in FIG. 2 due to the large volume of water. In another process, the correction values F_{K3} and F_{K4} are dependent upon the reference variable F and are selected by an operator to have, for example, a high value when a high temperature T₁ is selected and a low value when a low temperature T₁ is selected.

FIG. 4 shows a further process performed by the device for inductively heating up the heating element 4, which is the same as the process in FIG. 2 as far as time t₁, when the operator simultaneously presses the keys 20 and triggers the start signal. As described in FIG. 2, the heat output P of the inductor 10 is strongly reduced following giving of the start signal, in order to end the process of heating up the water. Depending on the nature of derivation of the reference variable from one or more electrical variables of the inductor 10, the systematic error of the reference variable F depending on the heat output P of the inductor 10 may arise. In FIG. 4 a dependence of the reference variable F on the heat output P is shown, in which the reference variable F also falls when there is a fall in the heat output P. If the reference value F₁ is now determined directly after the start signal and still before downward regulation of the heat output P, the means 14 or the control unit 12 will upwardly regulate the reference variable F, which has decreased from the reference value F₁ to a value F₄ due to the fall in the heat output P, to the reference value F₁, as shown in FIG. 4. This is associated with a decrease in the temperature T_{H} of the heating element 4 from the temperature T₂ to the temperature T₃, as a result of which the water cools markedly and rapidly falls below the desired temperature T₁. This systematic error may be eliminated manually by a manual correction at time t₂.

FIG. 5 shows a process by which the systematic error shown in FIG. 4 is counteracted. The reference value F₁ is not formed immediately after the start signal, but the heat output P is first of all lowered to an intermediate value P_{Z} and held there briefly until time t₂. Due to the systematic error, the reference variable F falls to the value F₄ and rises slightly until time t₂, due to cooling of the heating element 4 from the temperature T₂ to the temperature T₃. During this time the whole system may pass from the heating-up state prior to time t₁ and settle into a less dynamic state in which the reference value F₃ is not formed until time t₂ and the reference variable F is adjusted to this reference value F₃. By this means the water which, following a brief period of further heating up due to residual warmth in the heating element 4 and cooling by mixing in the pan 6, has now become too cool, is again brought to the desired temperature T₁.

The intermediate value P_{Z} is selected in such a way that it substantially corresponds to the output required for maintenance of a desired temperature T1, as shown in FIG. 5. Alternatively, it is possible to set the intermediate value P_{Z} to a value already established prior to the start signal, as a result of which the control is especially simple.

### KEY TO REFERENCE NUMERALS

2 Device
4 Heating element
6 Pan
8 Base plate
10 Inductor
12 Control unit
14 Means
16 Correction means
18 Inputting means
20 Key
F Reference variable
F₁ Reference value
F₂ Reference value
F₃ Reference value
F₄ Value
F_{K1} Correction value
F_{K2} Correction value
F_{K3} Correction value
F_{K4} Correction value
P Heat output
P_{Z} Intermediate value
T_{H} Temperature
T_{W} Temperature
T₁ Temperature
T₂ Temperature
T₃ Temperature
T₄ Temperature
t₀ Time
t₁ Time
t₂ Time

1-13. (canceled)

14. A device for heating up a heating element, in particular with an inductor, a radiant element or a gas burner, and comprising means for recording a reference variable dependent upon a temperature of the heating element, means for forming a reference value from the reference variable and for controlling the temperature on the basis of controlling the reference variable with the aid of the reference value, and correcting means for correcting the reference value for control of the heating element temperature.

15. The device as claimed in claim 14, wherein the correcting means has an inputting means for input of a correcting command by an operator for the purpose of correcting the reference value.

16. The device as claimed in claim 14, wherein the correcting means is prepared for the control operation purpose of altering the reference value by a correction value in response to a correction command.

17. The device as claimed in claim 14, wherein the correcting means is prepared for the purpose of automatically correcting the reference value at a temperature control start point, in particular for altering the reference value by a correction value.

18. The device as claimed in claim 16, wherein the correction value is a preset value.

19. The device as claimed in claim 16, wherein the correction value is dependent upon the reference variable.

20. The device as claimed in claim 16, wherein the correction value is dependent upon a heating parameter determined prior to the control operation.

21. The device as claimed in claim 16, wherein the correction value is dependent upon a determined characteristic of a cooked product to be heated up.

22. The device as claimed in claim 14, wherein the correcting means is prepared for the purpose of correcting the reference variable following a start signal for initiating the temperature control and for forming the reference value from the corrected reference variable.

23. The device as claimed in claim 22, wherein the correction comprises a reduction of the heat output for the heating element to an intermediate value.

24. The device as claimed in claim 23, wherein the intermediate value is a value already established prior to the start signal.

25. The device as claimed in claim 23, wherein the intermediate value substantially corresponds to the output required to maintain a desired temperature of the heating element.

26. The device as claimed in claim 14, wherein the reference variable is derived from an electrical variable of an inductor.

27. A cooking appliance comprising:
a heating element heated by a heating means selected from the group consisting of an inductor, a radiant element, or a gas burner;
means for recording a reference variable, the reference variable being dependent upon a temperature of the heating element;
means for forming a reference value from the reference variable and for controlling the heating element temperature on the basis of controlling the reference variable with the aid of the reference value; and
correcting means for correcting the reference value, wherein the reference value may be corrected by a correction value in response to an outside manual input command or by an automatic correction value.

28. The device as claimed in claim 27, wherein the correction value is a preset value.

29. The device as claimed in claim 27, wherein the correction value is dependent upon the reference variable, a heating parameter determined prior to the control operation, or a determined characteristic of a cooked product to be heated up.

30. The device as claimed in claim 27, wherein the correcting means corrects the reference variable following a start signal for initiating the temperature control and forms a new reference value from the corrected reference variable.

31. The device as claimed in claim 30, wherein the correction comprises a reduction of the heat output for the heating element to an intermediate value.

32. The device as claimed in claim 31, wherein the intermediate value is a value already established prior to the start signal.

33. The device as claimed in claim 31, wherein the intermediate value substantially corresponds to the output required to maintain a desired temperature of the heating element.
